(19) United States
(12) Patent Application Publication
(10) Pub. No.: US 2017/0294947 A1
(43) Pub. Date: Oct. 12, 2017

(54) FRONT-END ARCHITECTURE HAVING SWITCHABLE DUPLEXER

(71) Applicant: SKYWORKS SOLUTIONS, INC., Woburn, MA (US)

(72) Inventors: Christopher Robert LITTLE, Gilroy, CA (US); David Scott WHITEFIELD, Andover, MA (US)

(21) Appl. No.: 15/482,756

(22) Filed: Apr. 8, 2017

Related U.S. Application Data
(60) Provisional application No. 62/320,467, filed on Apr. 9, 2016.

(51) Int. Cl. H04B 7/06; H04B 1/40; H04B 1/00

(52) U.S. Cl. CPC H04B 7/0604; H04B 1/0064; H04B 1/006; H04B 1/40; H04B 1/3833

(57) ABSTRACT

Front-end architecture having switchable duplexer. In some embodiments, a front-end architecture can include a first receive signal path having a first receive filter coupled to a first antenna, a second receive signal path having a second receive filter coupled to a second antenna, and a transmit signal path having a transmit filter. The front-end architecture can further include a signal routing assembly configured to couple the transmit filter to the first antenna in a first mode, and to couple the transmit filter to the second antenna in a second mode.

### CROSS-REFERENCE TO RELATED APPLICATION(S)

This application claims priority to U.S. Provisional Application No. 62/320,467 filed Apr. 9, 2016, entitled FRONT-END ARCHITECTURE HAVING SWITCHABLE DUPLEXER, the disclosure of which is hereby expressly incorporated by reference herein in its respective entirety.

### BACKGROUND

### Field

The present disclosure relates to front-end architectures in wireless applications.

### Description of the Related Art

In wireless applications, a front-end typically facilitates transmission of a power-amplified signal through an antenna. The same front-end typically facilitates low-noise amplification of a received signal, either from the same antenna or another antenna.

In some wireless applications, transmit and receive operations can be achieved simultaneously through, for example, a duplexer. Such a duplexer typically includes a transmit filter and a receive filter.

### SUMMARY

According to a number of implementations, the present disclosure relates to a front-end architecture that includes a first receive signal path including a first receive filter coupled to a first antenna, a second receive signal path including a second receive filter coupled to a second antenna, and a transmit signal path including a transmit filter. The front-end architecture further includes a signal routing assembly configured to couple the transmit filter to the first antenna in a first mode, and to couple the transmit filter to the second antenna in a second mode.

In some embodiments, the first antenna can include a main antenna, and the second antenna can include a diversity antenna. Each of the first receive signal path and the second receive signal path can further include a low-noise amplifier implemented on an output side of the corresponding receive filter. In some embodiments, at least one of the first receive signal path and the second receive signal path can further include a phase shifter implemented on an input side of the corresponding receive filter.

In some embodiments, at least one of the first receive signal path and the second receive signal path can be one of a plurality of receive signal paths arranged in parallel and configured to allow a selected receive signal path to be operational. The plurality of parallel receive signal paths can share the corresponding low-noise amplifier as a common low-noise amplifier and also can have a common output node. Each of the plurality of parallel receive signal paths can include a first band-selection switch implemented on an input side of the corresponding receive filter, and a second band-selection switch implemented on an output side of the corresponding receive filter.

In some embodiments, the transmit signal path can further include a power amplifier implemented on an input side of the transmit filter. In some embodiments, the transmit signal path can be one of a plurality of transmit signal paths arranged in parallel and configured to allow a selected transmit signal path to be operational. The plurality of parallel transmit signal paths can share the power amplifier as a common power amplifier and also can have a common output node. Each of the plurality of parallel transmit signal paths can include a first band-selection switch implemented on an input side of the corresponding transmit filter, and a second band-selection switch implemented on an output side of the corresponding transmit filter.

In some embodiments, the signal routing assembly can include a plurality of switches implemented between the first antenna and the second antenna. The plurality of switches of the signal routing assembly can be configured to allow pairing of the transmit signal path with the first receive signal path for a first duplex operation when in the first mode, and pairing of the transmit signal path with the second receive signal path for a second duplex operation when in the second mode. The plurality of switches can include a first assembly of one or more switches configured to pair the transmit signal path with the first receive signal path when in the first mode, and to allow pairing of the transmit signal path with the second receive signal path when in the second mode. The first assembly of one or more switches can be configured to provide a switching functionality that includes a single-pole-double-throw functionality. The single pole can be coupled to the transmit signal path, a first of the double throw can be coupled to the first antenna, and a second of the double throw can be coupled to a first end of a routing line.

In some embodiments, the first assembly of one or more switches can include a first single-pole-single-throw switch implemented between the transmit filter and the first antenna, and a second single-pole-single-throw switch implemented between the transmit filter and a first end of a routing line. In some embodiments, the first assembly of one or more switches can include a multiplexed switch configured to couple the transmit filter and the first antenna when in the first mode, and to couple the transmit filter and a first end of a routing line when in the second mode.

In some embodiments, the plurality of switches can further include a second switch implemented to switchably couple a second end of a routing line with the second antenna, such that the transmit signal path is coupled to the second antenna through the routing line when in the second mode, and the transmit signal path is uncoupled from the second antenna when in the first mode. In some embodiments, the routing line can include a lossy cable.

In some embodiments, the first receive filter can be always connected to the first antenna, and the second receive filter can be always connected to the second antenna. The transmit filter and the first receive filter can form a first switched duplexer operational with the first antenna when in the first mode. The transmit filter and the second receive filter can form a second switched duplexer operational with the second antenna when in the second mode.

In some implementations, the present disclosure relates to a method for operating a wireless device. The method includes providing a first receive signal path including a first receive filter coupled to a first antenna, a second receive signal path including a second receive filter coupled to a second antenna, and a transmit signal path including a transmit filter. The method further includes generating a control signal representative of a first mode or a second mode. The method further includes performing one or more switching operations based on the control signal to couple the transmit filter to the first antenna when in the first mode, and to couple the transmit filter to the second antenna when in the second mode.

In a number of implementations, the present disclosure relates to a radio-frequency module that includes a packaging substrate configured to receive a plurality of components, and a signal routing circuit implemented on the packaging substrate. The signal routing circuit includes a first antenna node configured to be connected to a first antenna and a first receive signal path, a transmit input node configured to be connected to a transmit signal path, and a swap node configured to be connected to a routing line. The signal routing circuit is further configured to couple the transmit input node and the first antenna node when in a first mode, and to couple the transmit input node and the swap node when in a second mode.

In some teachings, the present disclosure relates to a signal routing circuit for a wireless device. The signal routing circuit includes a first antenna node configured to be connected to a first antenna and a first receive signal path, a transmit input node configured to be connected to a transmit signal path, and a swap node configured to be connected to a routing line. The signal routing circuit further includes an assembly of switches configured to couple the transmit input node and the first antenna node when in a first mode, and to couple the transmit input node and the swap node when in a second mode.

In some embodiments, the signal routing circuit can further include the routing line connected to the swap node. In some embodiments, the signal routing circuit can further include a second antenna node configured to be connected to a second antenna and a second receive signal path. The second antenna node can be further configured to be switchably connected to the routing line. The assembly of switches can be further configured to disconnect the second antenna node from the routing line when in the first mode, and to connect the second antenna node to the routing line when in the second mode.

In accordance with a number of implementations, the present disclosure relates to a wireless device that includes a transceiver configured to process signals, a first antenna and a second antenna, each in communication with the transceiver, and a front-end architecture implemented to route the signals between the transceiver and either or both of the first and second antennas. The front-end architecture includes a first receive signal path having a first receive filter coupled to the first antenna, a second receive signal path having a second receive filter coupled to the second antenna, and a transmit signal path having a transmit filter. The front-end architecture further includes a signal routing assembly configured to couple the transmit filter to the first antenna in a first mode, and to couple the transmit filter to the second antenna in a second mode.

In some embodiments, the first antenna can include a main antenna, and the second antenna can include a diversity antenna. In some embodiments, the wireless device can include a cellular phone. In some embodiments, the cellular phone can be configured to include a frequency-division duplexing mode of operation.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a block diagram of a front-end (FE) architecture configured to perform transmit (Tx) and receive (Rx) operations utilizing a first antenna and a second antenna.

FIG. 2 shows an example of a wireless device that can include two antennas.

FIGS. 3A and 3B show an example of a radio-frequency front-end (RFFE) circuitry that can provide the example antenna connections of FIG. 2.

FIG. 4 shows a front-end architecture configured to perform transmit (Tx) and receive (Rx) operations utilizing a first antenna and a second antenna.

FIG. 5A shows an example configuration of the front-end architecture of FIG. 4, in which a Tx amplification path is coupled to the first antenna through a first switch.

FIG. 5B shows an example configuration of the front-end architecture of FIG. 4, in which the Tx amplification path is coupled to the second antenna through the first switch, a routing line, and a second switch.

FIG. 6A shows a direct connect mode of a front-end architecture in which the first switch of FIGS. 4 and 5 can be implemented to provide a single-pole-double-throw (SPDT) functionality, and the second switch can be implemented to provide a single-pole-single-throw (SPST) functionality.

FIG. 6B shows a swap mode of the front-end architecture of FIG. 6A.

FIG. 7A shows a direct connect mode of a front-end architecture that is similar to the example of FIG. 6A, but in which a phase shifter is implemented in front of a receive filter.

FIG. 7B shows a swap mode of the front-end architecture of FIG. 7A.

FIG. 8A shows a direct connect mode of a front-end architecture in which each of a power amplifier (PA) and a plurality of low-noise amplifiers (LNAs) has associated with it a plurality of signal filtering paths.

FIG. 8B shows a swap mode of the front-end architecture of FIG. 8A.

FIG. 9A shows a direct connect mode of another example of a front-end architecture in which each of a power amplifier (PA) and a plurality of low-noise amplifiers (LNAs) has associated with it a plurality of signal filtering paths.

FIG. 9B shows a swap mode of the front-end architecture of FIG. 9A.

FIG. 10A shows a direct connect mode of yet another example of a front-end architecture in which each of a power amplifier (PA) and a plurality of low-noise amplifiers (LNAs) has associated with it a plurality of signal filtering paths.

FIG. 10B shows a swap mode of the front-end architecture of FIG. 10A.

FIG. 11A shows a direct connect mode of a front-end architecture that is similar to the example of FIG. 10A, but with inactive filtering paths removed for simplification.

FIG. 11B shows a swap mode of the front-end architecture of FIG. 11A.

FIG. 12A shows a direct connect mode of a front-end architecture that is similar to the example of FIG. 3A, but with inactive filtering paths removed for simplification.

FIG. 12B shows a swap mode of the front-end architecture of FIG. 12A.

FIG. 13 shows a simulated insertion loss plot for an Rx signal path associated with the first antenna and a TRx functionality block, when the front-end architecture of FIGS. 11A and 11B is in the swap mode.

FIG. 14 shows a simulated insertion loss plot for an Rx signal path associated with the first antenna and an Rx functionality block, when the front-end architecture of FIGS. 12A and 12B is in the swap mode.

FIG. 15 shows a simulated insertion loss plot for an Rx signal path associated with the second antenna and an Rx functionality block, when the front-end architecture of FIGS. 11A and 11B is in the swap mode.

FIG. 16 shows a simulated insertion loss plot for an Rx signal path associated with the second antenna and a TRx functionality block, when the front-end architecture of FIGS. 12A and 12B is in the swap mode.

FIG. 17 shows a simulated insertion loss plot for a Tx signal path associated with the second antenna and a TRx functionality block, when the front-end architecture of FIGS. 11A and 11B is in the swap mode.

FIG. 18 shows a simulated Tx insertion loss plot for a Tx signal path associated with the second antenna and a TRx functionality block, when the front-end architecture of FIGS. 12A and 12B is in the swap mode.

FIG. 19 depicts an example wireless device having one or more advantageous features described herein.

### DETAILED DESCRIPTION OF SOME EMBODIMENTS

The headings provided herein, if any, are for convenience only and do not necessarily affect the scope or meaning of the claimed invention.

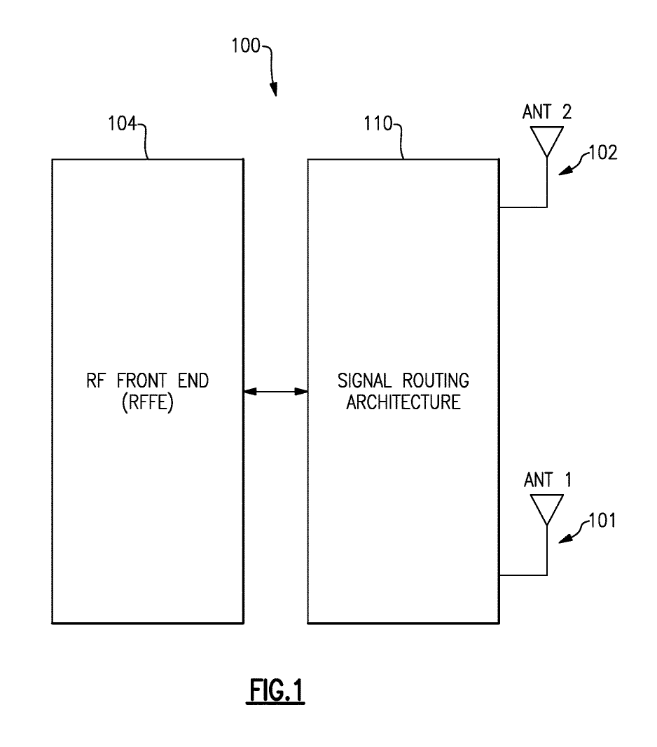

FIG. 1 depicts a block diagram of a front-end (FE) architecture 100 configured to perform transmit (Tx) and receive (Rx) operations utilizing a first antenna (Ant 1) 101 and a second antenna (Ant 2) 102. Such an FE architecture can include a radio-frequency front-end (RFFE) portion 104 and a signal routing architecture 110. Various examples related to the FE architecture 100 are described herein in greater detail.

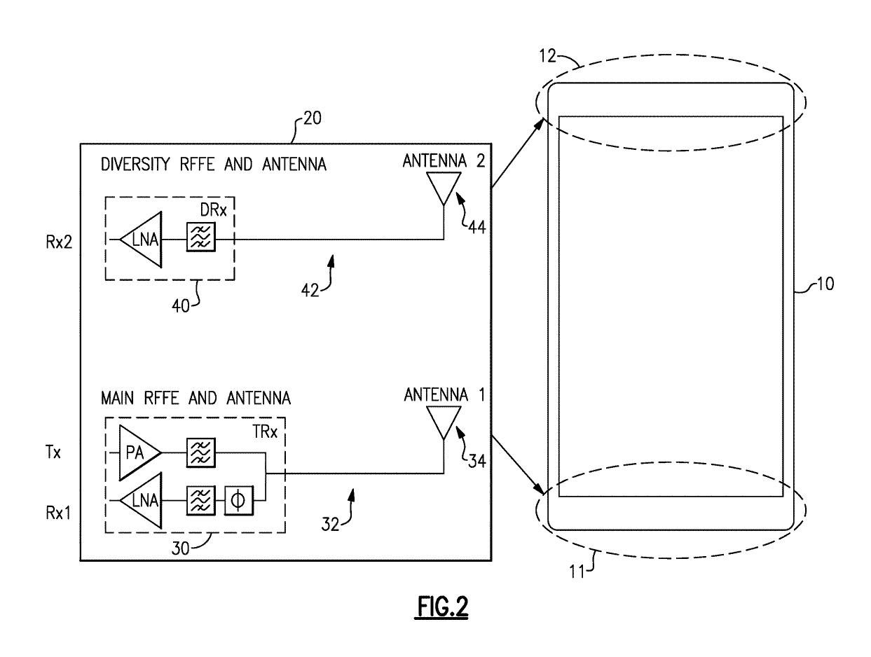

FIG. 2 shows an example of a wireless device 10 such as a cellular handset or a mobile device that can include two antennas. In such a wireless device, there are typically two portions of a radio-frequency (RF) FE (RFFE) circuitry 20. These sections are typically located at opposite ends of the wireless device 10. For example, a main or primary portion of the RFFE circuitry 20 can be implemented at or near one end portion 11 of the wireless device 10, and a diversity portion of the RFFE circuitry 20 can be implemented at or near the other end portion 12 of the wireless device 10.

In the example of FIG. 2, each of the main and diversity portions of the RFFE circuitry 20 has a receive circuitry that can be active simultaneously with another receive circuitry, and therefore allow processing of received signals with spatial-diversity. These signals are typically combined by a cellular baseband system and can provide improved receive sensitivity over a single-receive system. In some embodiments, such an RFFE circuitry 20 can provide a multiple-in-multiple-out (MIMO) functionality that can be utilized in, for example, Lone-Term Evolution (LTE) (sometimes associated with or referred to as 4G wireless service) cellular operations.

Referring to the example of FIG. 2, the main portion of the RFFE 20 can be configured to include transmit (Tx) and receive (Rx1) functionalities. Such Tx and Rx1 functionalities are collectively indicated as a TRx functional block 30 that includes, for example, a power amplifier (PA) and a filter coupled to the output of the PA for the Tx operation, and a phase shifter, a filter, and a low-noise amplifier (LNA) for the Rx1 operation. Such TRx operations can be performed through a first antenna (e.g., a main antenna) 34, through a common signal path 32.

Referring to the example of FIG. 2, the diversity portion of the RFFE 20 can be configured to include a receive (Rx2) functionality. Such an Rx2 functionality is indicated as a diversity receive (DRx) functional block 40 that includes, for example, a filter and an LNA for the Rx2 operation. Such an Rx2 operation can be performed with a second antenna (e.g., a diversity antenna) 44, through a signal path 42.

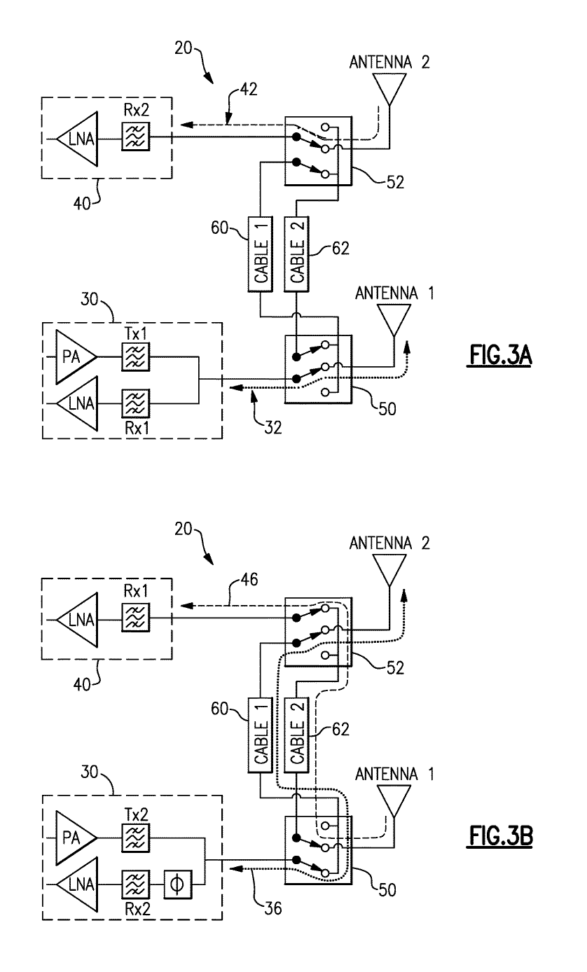

FIGS. 3A and 3B show an example of an RFFE circuitry 20 that can provide the example antenna connections of FIG. 2. More particularly, FIG. 3A shows an example operating mode in which TRx operations associated with a TRx functional block 30 are being performed with a first antenna (Antenna 1), and a diversity Rx operation associated with an Rx functional block 40 is being performed with a second antenna (Antenna 2).

In FIG. 3A, the TRx functional block 30 is shown to include a PA for power amplification of an RF signal to be transmitted through the first antenna (Antenna 1) through a signal path indicated as 32, and a filter Tx1 for filtering such an amplified RF signal. The TRx functional block 30 is shown to further include an LNA for amplification of an RF signal received through the first antenna (Antenna 1) and routed through the signal path 32. Such a received RF signal is shown to be filtered by a filter Rx1. Accordingly, the example filters Tx1 and Rx1 are indicated as such since they operate with the first antenna (Antenna 1). It is also noted that the Tx1 and Rx1 filters provide a duplexer functionality for the corresponding Tx and Rx signals.

Referring to FIG. 3A, the Rx functional block 40 is shown to include an LNA for amplification of an RF signal received through the second antenna (Antenna 2) and routed through a signal path indicated as 42. Such a received RF signal is shown to be filtered by a filter Rx2. Accordingly, the example filter Rx2 is indicated as such since it operates with the second antenna (Antenna 2).

For the purpose of description, the example operating mode of FIG. 3A can be referred to as a direct connect mode. In such a direct connect mode, a first switch 50 can be configured to facilitate the signal path 32 between the TRx functional block 30 and the first antenna (Antenna 1). Similarly, a second switch 52 can be configured to facilitate the signal path 42 between the Rx functional block 40 and the second antenna (Antenna 2).

As further shown in FIG. 3A, the switches 50 and 52 can be configured to interconnect the TRx functional block 30 to the second antenna (Antenna 2) through a first routing line 60, and to interconnect the Rx functional block 40 to the first antenna (Antenna 1) through a second routing line 62. In the direct connect mode of FIG. 3A, however, such signal routing lines are not utilized. In various examples, such routing lines are sometimes referred to as cables.

FIG. 3B shows the RFFE circuitry 20 in an example operating mode that can be referred to as a swap mode. In such a mode, the switches 50 and 52 can be operated such that the TRx functional block 30 is connected to the second antenna (Antenna 2) through the signal cable 60, and the Rx functional block 40 is connected to the first antenna (Antenna 1) through the signal cable 62. Accordingly, the example filters Tx2 and Rx2 of the TRx functional block 30 are indicated as such since they operate with the second antenna (Antenna 2) through a signal path indicated as 36. Similarly, the example filter Rx1 of the Rx functional block 40 is indicated as such since it operates with the first antenna (Antenna 1) through a signal path indicated as 46. It is also noted that the Tx2 and Rx2 filters of the TRx functional block 30 provide a duplexer functionality for the corresponding Tx and Rx signals.

The foregoing swap mode of operation can address situations where antenna efficiencies may be degraded in various ways by changes in external environment (e.g., presence of hands, head, etc.). For example, the capability to swap transmit path from one antenna to the other can allow selection of an antenna depending on which one has a greater antenna efficiency at a given time.

Referring to FIGS. 3A and 3B, it is noted that the foregoing swap mode of operation involves two separate routing lines (60 and 62) to interconnect the TRx functional block 30 to the second antenna (Antenna 2) (through the routing line 60) and to interconnect the Rx functional block 40 to the first antenna (Antenna 1) (through the routing line 62). It is further noted that when in the direct connect mode (FIG. 3A), each of the two signal paths 32, 42 is shown to include at least one switch (e.g., switch 50 for the signal path 32, and switch 52 for the signal path 42). When in the swap mode (FIG. 3B), each of the two signal paths 36, 46 is shown to include at least two switches (e.g., switches 50 and 52), as well as a relatively long routing line (e.g., routing line 60 for the signal path 36, and routing line 62 for the signal path 46). Such switches and/or routing lines can introduce, for example, undesirable losses for an amplified signal to be transmitted, as well as for received signals to be amplified.

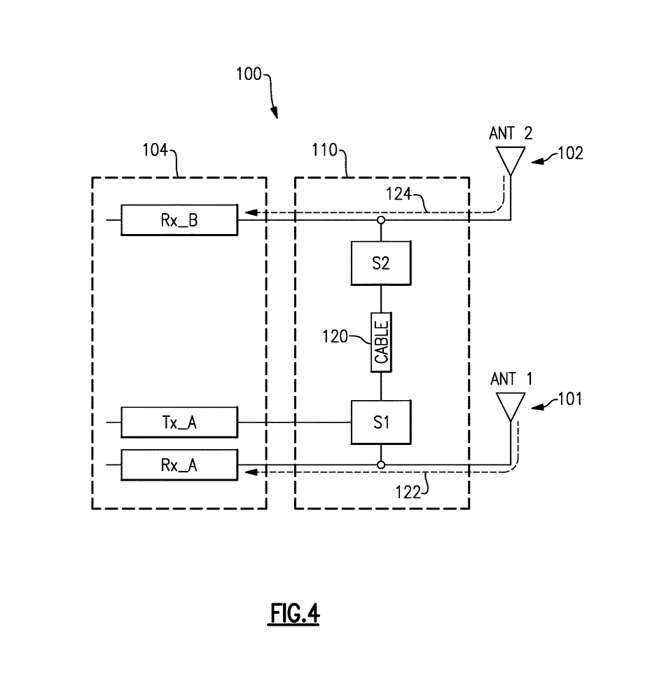

FIG. 4 shows an FE architecture 100 configured to perform transmit (Tx) and receive (Rx) operations utilizing a first antenna (Ant 1) 101 and a second antenna (Ant 2) 102. Such an FE architecture can include an RFFE portion 104 and a signal routing architecture 110. As described herein, the FE architecture 100 can be configured to address some or all of the foregoing performance issues associated with the example RFFE circuitry 20 of FIGS. 3A and 3B.

FIG. 4 shows that in some embodiments, the RFFE portion 104 can include a Tx amplification path indicated as Tx_A, a first Rx amplification path indicated as Rx_A, and a second Rx amplification path indicated as Rx_B. In some embodiments, each of the three amplification paths can include a filter. The signal routing architecture 110 can be configured such that the Tx_A amplification path is capable of being connected to the first antenna 101 or the second antenna 102.

In some embodiments, the Tx_A amplification path can be swapped between the first and second antennas 101, 102, and each of the Rx_A and Rx_B amplification paths can remain coupled the its corresponding antenna in a dedicated manner. For example, the Rx_A amplification path can be coupled to the first antenna 101 in a dedicated manner to provide a signal path 122, and the Rx_B amplification path can be coupled to the second antenna 102 in a dedicated manner to provide a signal path 124.

To swap the connection of the Tx_A amplification path between the first and second antennas, a first switch S1, a routing line 120, and a second switch S2 can be implemented as shown between the first and second antennas 101, 102. The first switch S1 can also be coupled to the Tx_A amplification path. Accordingly, the Tx_A amplification path can be coupled to the first antenna 101 through the first switch S1. The Tx_A amplification path can also be coupled to the second antenna 102 through the first switch S1, the routing line 120, and the second switch S2.

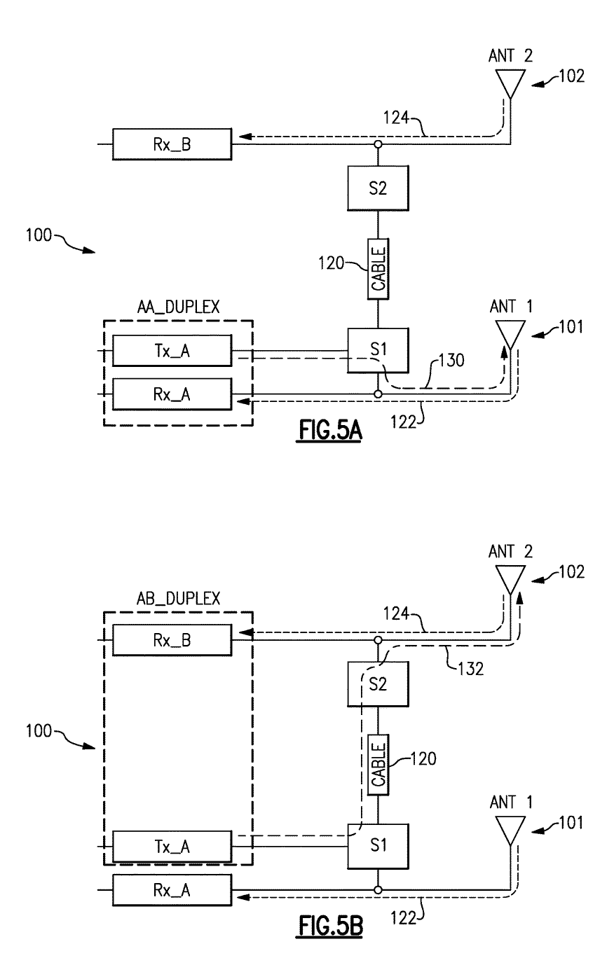

FIG. 5A shows an example configuration of the FE architecture 100 of FIG. 4, in which the Tx_A amplification path is coupled to the first antenna 101 through the first switch S1. Accordingly, a signal path 130 can be provided between the Tx_A amplification path and the first antenna 101. The first antenna 101 is also shown to be coupled to the Rx_A amplification path through the signal path 122. Accordingly, the Tx_A amplification path and the Rx_A amplification path can operate in a duplex mode, indicated as an AA_Duplex mode. For the purpose of description, the example of FIG. 5A can be referred to as a direct connect mode. In such a direct connect mode, the second antenna 102 is shown to be coupled to the Rx_B amplification path through the signal path 124.

FIG. 5B shows an example configuration of the FE architecture 100 of FIG. 4, in which the Tx_A amplification path is coupled to the second antenna 101 through the first switch S1, the routing line 120, and the second switch S2. Accordingly, a signal path 132 can be provided between the Tx_A amplification path and the second antenna 102. The second antenna 102 is also shown to be coupled to the Rx_B amplification path through the signal path 124. Accordingly, the Tx_A amplification path and the Rx_B amplification path can operate in a duplex mode, indicated as an AB_Duplex mode. For the purpose of description, the example of FIG. 5B can be referred to as a swap mode. In such a swap mode, the first antenna 101 is shown to be coupled to the Rx_A amplification path through the signal path 122.

As described herein, filters associated with the Tx_A amplification path and the Rx_A amplification path can effectively function together to provide the duplex functionality with the first antenna 101, as in the example of FIG. 5A. Similarly, filters associated with the Tx_A amplification path and the Rx_B amplification path can effectively function together to provide the duplex functionality with the second antenna 102, as in the example of FIG. 5B. Accordingly, the Tx filter associated with the Tx_A amplification path can form effectively a switched duplexer with the Rx filter associated with the Rx_A amplification path or the Rx filter associated with the Rx_B amplification path.

It is noted that by having the Tx_A amplification path swap between the first and second antennas 101, 102 while each of the Rx_A and Rx_B amplification paths remains coupled to its respective antenna (101 or 102), a number of desirable features can be realized. For example, and assuming that a routing line is not utilized or needed in the direct connect mode, one routing line (e.g., routing line 120) can be utilized for the swap mode (FIG. 5B), as opposed to the two routing lines in the example of FIG. 3B. Further, since such a single routing line (120 in FIG. 5B) is utilized only for transmission purpose, loss associated with such a routing line affects only a Tx signal which is not as critical as a routing line loss of an Rx signal.

It is also noted that in the example of FIGS. 5A and 5B, Rx signals from the first and second antennas 101, 102 can be provided to the Rx_A and Rx_B amplification paths, respectively, without passing through a switch. Accordingly, losses to such Rx signals can be reduced. Further, switching configuration can be simplified since the swap mode involves the Tx_A amplification path and not the receive amplification paths (Rx_A and Rx_B).

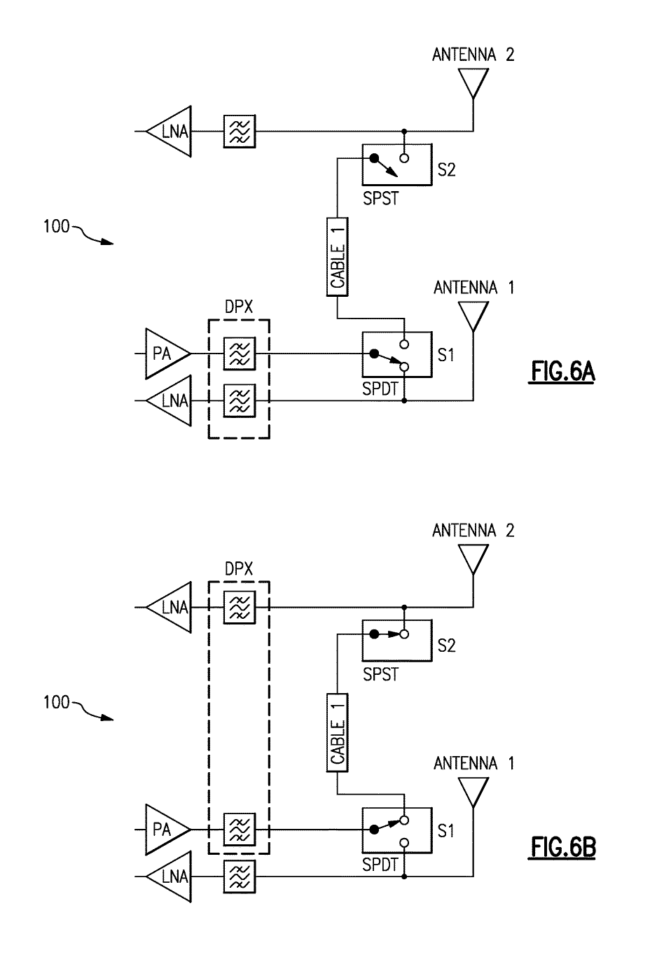

FIGS. 6-10 show various configurations that can be more specific examples of the FE architecture 100 of FIGS. 4 and 5. FIGS. 6A and 6B show a direct connect mode and a swap mode, respectively, of an FE architecture 100 in which the first switch S1 of FIGS. 4 and 5 can be implemented to provide a single-pole-double-throw (SPDT) functionality, and the second switch S2 can be implemented to provide a single-pole-single-throw (SPST) functionality. The example SPDT switch (S1) can be configured such that the pole is coupled to an output of a Tx filter (whose input is coupled to an output of a PA), and the two throws are coupled to a first end of a routing line (Cable 1, 120 in FIGS. 4 and 5) and a first antenna (Antenna 1, 101 in FIGS. 4 and 5). The example SPST switch (S2) can be configured to provide a switchable coupling between a second end of the routing line (Cable 1) and a second antenna (Antenna 2, 102 in FIGS. 4 and 5).

Accordingly, when in the direct connect mode of FIG. 6A, the SPDT switch (S1) can be in a first state in which the output of the Tx filter is connected to the first antenna (Antenna 1) through the pole and the first throw. Thus, a Tx operation can be achieved through the PA, the Tx filter, the first switch S1, and the first antenna (Antenna 1), along with an Rx operation through the same antenna, a first Rx filter, and a first LNA. Another Rx operation can be achieved through the second antenna (Antenna 2), a second Rx filter, and a second LNA without having the signal received through the second antenna pass through a switch. In such a direct connect mode, the SPST switch (S2) can be in an open state to provide isolation.

When in the swap mode of FIG. 6B, the SPDT switch (S1) can be in a second state in which the output of the Tx filter is connected to the routing line (Cable 1) through the pole and the second throw, and the SPST switch (S2) can be in a closed state. Thus, Tx operation can be achieved through the PA, the Tx filter, the first switch S1, the routing line (Cable 1), the second switch S2, and the second antenna (Antenna 2) along with an Rx operation through the same antenna, the second Rx filter, and the second LNA. Another Rx operation can be achieved through the first antenna (Antenna 1), the first Rx filter, and the first LNA without having to pass through a switch.

It is noted that in the example of FIGS. 6A and 6B, different duplexer functionalities can be achieved by different combinations of the Tx filter and the two Rx filters. For example, in the direct connect mode of FIG. 6A, the first switch S1 interconnects the Tx filter and the first Rx filter so as to achieve a first duplexer functionality indicated as DPX in the dashed box. In another example, in the swap mode of FIG. 6B, the first switch S1 and the second switch S2 can be operated to interconnect the Tx filter and the second Rx filter so as to achieve a second duplexer functionality indicated as DPX in the dashed box.

It is noted that in some embodiments, Tx and Rx filters are implemented in a single 3-port component duplexer. Whether or not such Tx and Rx filters are physically combined into a single duplexer device, it is desirable to implement a design such that both Tx and Rx portions perform well. To accomplish or facilitate such performance of duplexer functionality, a phase shift element or circuit can be implemented for at least one of the Tx and Rx filters. For example, a phase shift element can be introduced in front of an Rx filter.

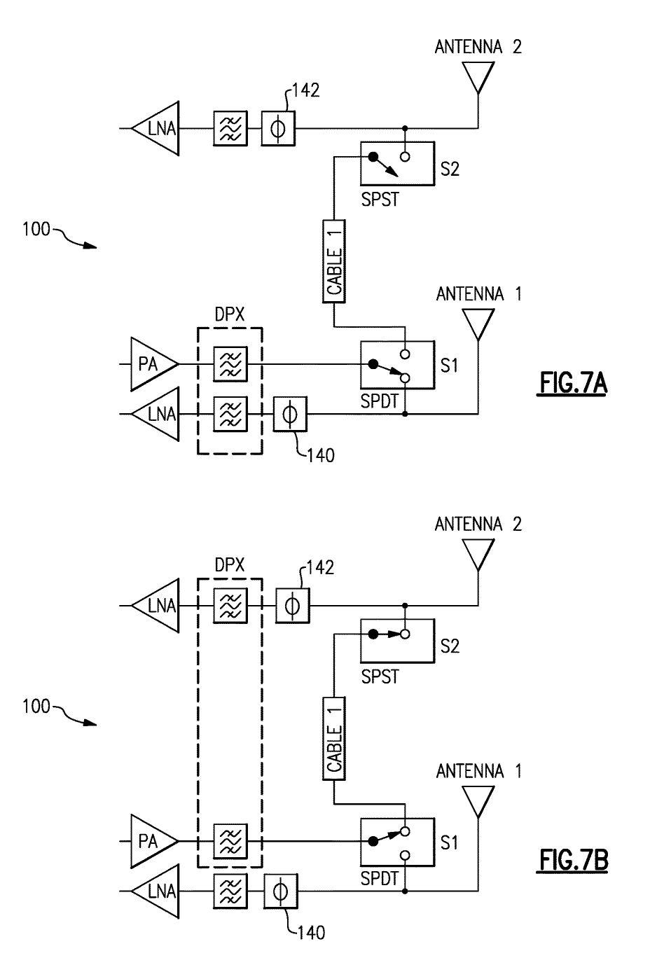

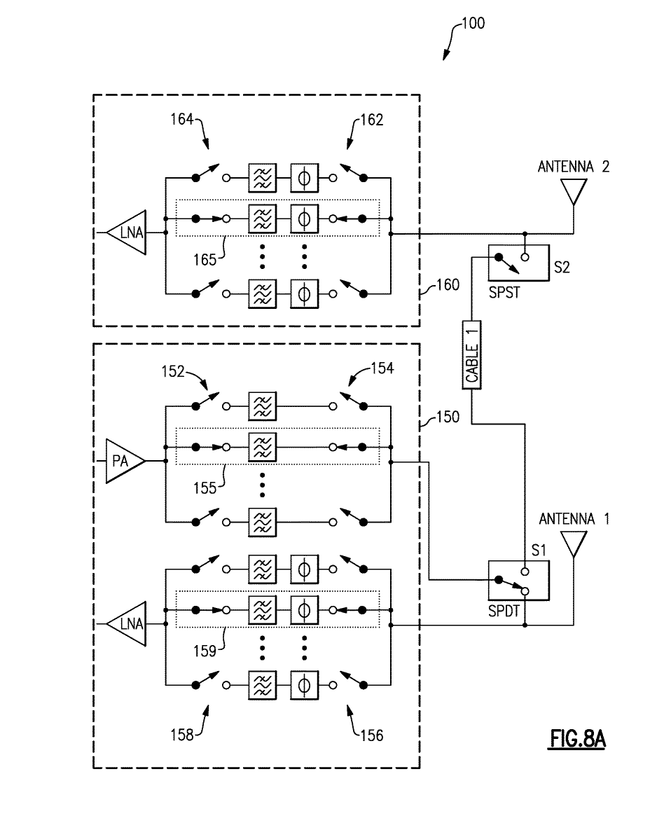

FIGS. 7A and 7B show a direct connect mode and a swap mode, respectively, of an FE architecture 100 that is similar to the example of FIGS. 6A and 6B. In the example of FIGS. 7A and 7B, however, a phase shifter 140 is shown to be implemented in front of the Rx filter associated with the first antenna (Antenna 1). Similarly, a phase shifter 142 is shown to be implemented in front of the Rx filter associated with the second antenna (Antenna 2). Accordingly, the phase shifters 140, 142 can provide the foregoing functionality when the Tx filter is switchably combined with either of the Rx filters.

In the examples of FIGS. 6 and 7, a single example signal filtering path is shown for each PA or LNA. In some embodiments, a given PA or an LNA may have associated with it a plurality of signal filtering paths, and one or more of such signal filtering paths can be selected for operation with the given PA or LNA. Further, there may be a plurality of PAs and/or LNAs in a given functional block, and each of such PAs and/or LNAs can have associated with it one or more signal filtering paths.

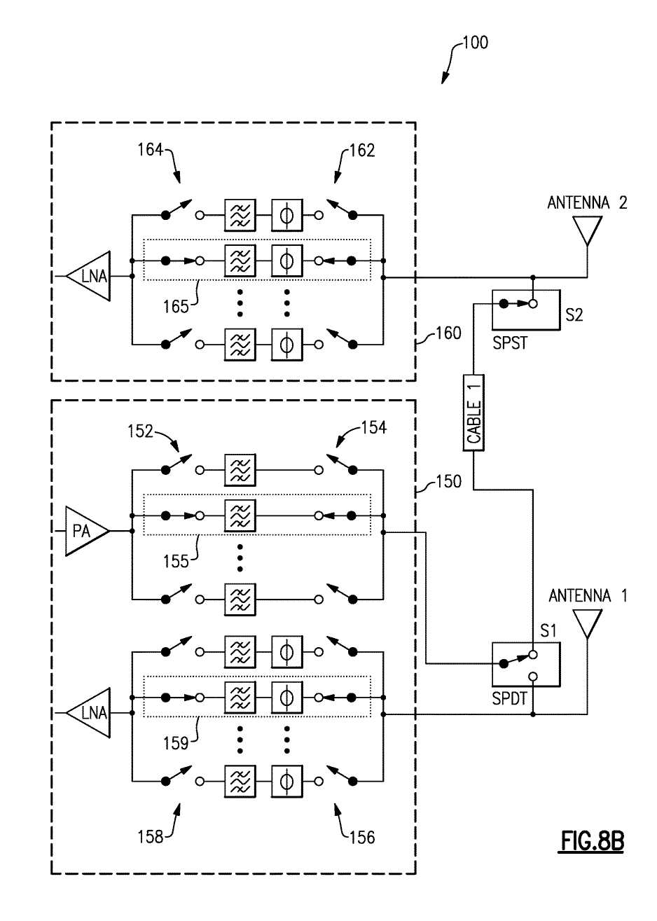

FIGS. 8A and 8B show a direct connect mode and a swap mode, respectively, of an FE architecture 100 in which each of the example PA and the example LNAs has associated with it a plurality of signal filtering paths. In the example of FIGS. 8A and 8B, a TRx functional block is indicated as 150, and an Rx functional block is indicated as 160.

In the TRx functional block 150, an output of the PA is shown to be connected to one side of an assembly of signal filtering paths. One or more of such signal filtering paths can be selected for operation utilizing, for example, switches 152 before corresponding Tx filters and switches 154 after the Tx filters. For example, a selected signal filtering path indicated as 155 is shown to have the corresponding switches 152 and 154 closed so as to couple the output of the PA to the first switch S1.

Similarly, in the TRx functional block 150, an input of the LNA is shown to be connected to one side of an assembly of signal filtering paths. One or more of such signal filtering paths can be selected for operation utilizing, for example, switches 156 before corresponding Rx filters and switches 158 after the Rx filters. For example, a selected signal filtering path indicated as 159 is shown to have the corresponding switches 156 and 158 closed so as to couple the first antenna (Antenna 1) to the input of the LNA.

Similarly, in the Rx functional block 160, an input of the LNA is shown to be connected to one side of an assembly of signal filtering paths. One or more of such signal filtering paths can be selected for operation utilizing, for example, switches 162 before corresponding Rx filters and switches 164 after the Rx filters. For example, a selected signal filtering path indicated as 165 is shown to have the corresponding switches 162 and 164 closed so as to couple the second antenna (Antenna 2) to the input of the LNA.

In the example of FIGS. 8A and 8B, a phase shifter is shown to be implemented on the input of each Rx filter. It will be understood that in some embodiments, a given Rx path may or may not have such a phase shifter.

In the example of FIGS. 8A and 8B, operations involving the selected signal filtering paths (e.g., 152, 159, 165) in the direct connect and swap modes can be similar to the example of FIGS. 7A and 7B. For example, switches S1 and S2 can be configured and operated as described in reference to FIGS. 7A and 7B to couple the selected Tx path 155 to the first antenna (Antenna 1) or the second antenna (Antenna 2). Accordingly, and similar to the example of FIG. 7A, the Tx filter of the selected Tx path 155 and the Rx filter of the selected Rx path 159 can achieve a first duplexer functionality when the FE architecture 100 is in the direct connect mode (FIG. 8A). Similarly, the Tx filter of the selected Tx path 155 and the Rx filter of the selected Rx path 165 can achieve a second duplexer functionality when the FE architecture 100 is in the swap mode (FIG. 8B).

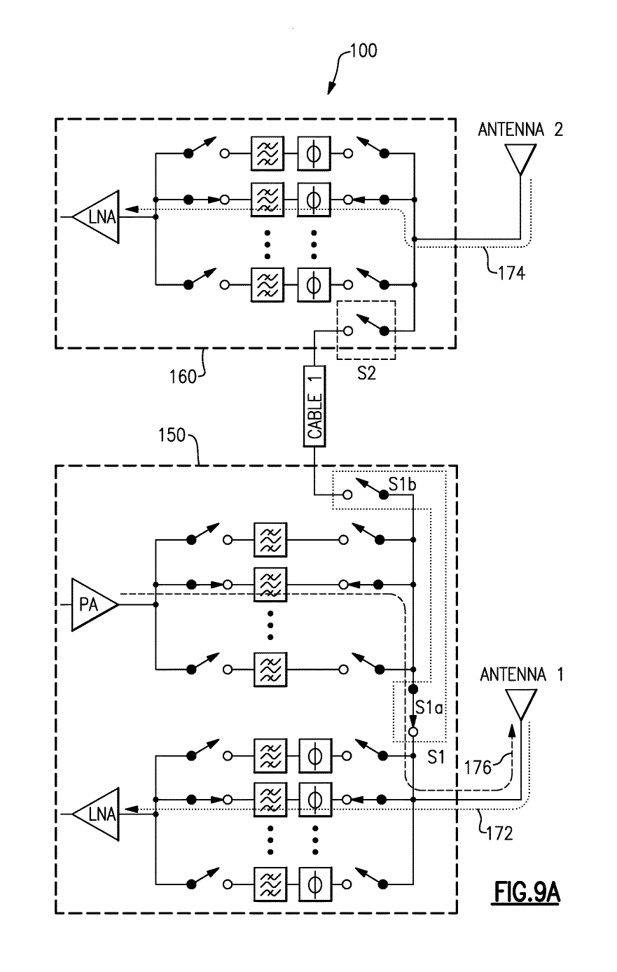

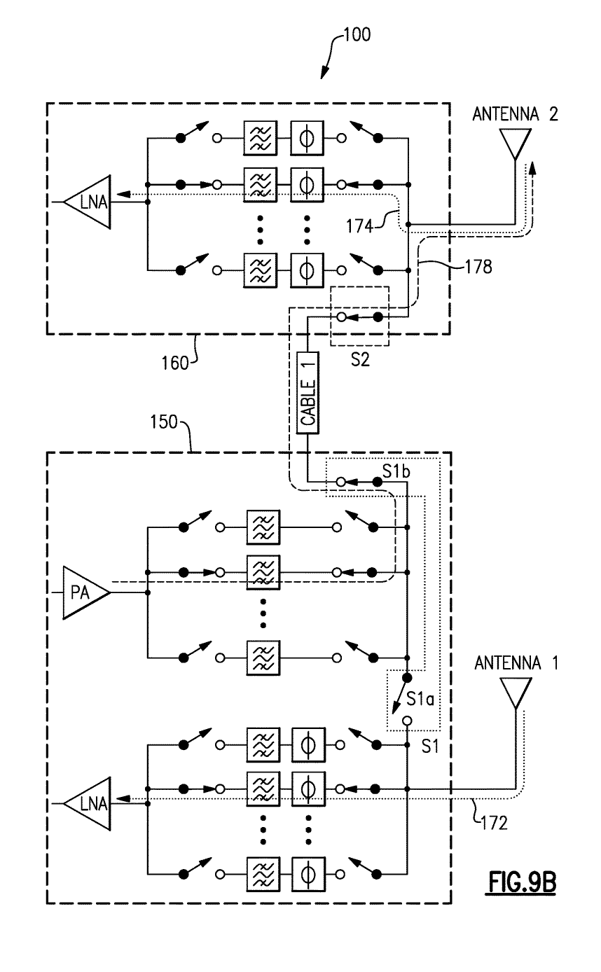

In the examples of FIGS. 6-8, the Tx swapping functionality between the first and second antennas is depicted as being performed with the first switch S1 implemented as an SPDT switch. FIGS. 9 and 10 show examples of how the switching functionality of S1 can be implemented to provide such an SPDT functionality.

FIGS. 9A and 9B show a direct connect mode and a swap mode, respectively, of an FE architecture 100 in which each of the example PA and the example LNAs has associated with it a plurality of signal filtering paths. In the example of FIGS. 9A and 9B, a TRx functional block is indicated as 150, and an Rx functional block is indicated as 160.

In the TRx functional block 150, an output of the PA is shown to be connected to one side of an assembly of signal filtering paths, similar to the example of FIGS. 8A and 8B. One or more of such signal filtering paths can be selected for operation utilizing switches before corresponding Tx filters and switches after the Tx filters. Similarly, in the TRx functional block 150, an input of the LNA is shown to be connected to one side of an assembly of signal filtering paths, similar to the example of FIGS. 8A and 8B. One or more of such signal filtering paths can be selected for operation utilizing switches before corresponding Rx filters and switches after the Rx filters.

Similarly, in the Rx functional block 160, an input of the LNA is shown to be connected to one side of an assembly of signal filtering paths, similar to the example of FIGS. 8A and 8B. One or more of such signal filtering paths can be selected for operation utilizing switches before corresponding Rx filters and switches after the Rx filters.

In the example of FIGS. 9A and 9B, a phase shifter is shown to be implemented on the input of each Rx filter. It will be understood that in some embodiments, a given Rx path may or may not have such a phase shifter.

In the example of FIGS. 9A and 9B, an input node for the foregoing assembly of LNA and its signal filtering paths in the TRx functional block 150 can be coupled to the first antenna (Antenna 1). Accordingly, such an input node can be referred to as an antenna node for the first antenna. Similarly, an input node for the foregoing assembly of LNA and its signal filtering paths in the Rx functional block 160 can be coupled to the second antenna (Antenna 2). Accordingly, such an input node can be referred to as an antenna node for the second antenna.

Referring to FIGS. 9A and 9B, an output node for the foregoing assembly of PA and its signal filtering paths in the TRx functional block 150 can be coupled to the antenna node for the first antenna (Antenna 1) through an SPST switch S1a. The output node for the assembly of PA and its signal filtering paths in the TRx functional block 150 can also be coupled to one end of the routing line (Cable 1) through an SPST switch S1b. The other end of the routing line can be coupled to the antenna node for the second antenna (Antenna 2) through an SPST switch S2.

Configured in the foregoing manner, the direct connect mode can be implemented as shown in FIG. 9A, in which the switch S1a is closed and each of the switches S1b and S2 is open. In such a mode, an amplified RF signal from the PA can be routed through a selected filtering path and to the antenna node for the first antenna (Antenna 1) through the closed switch S1a, so as to provide a Tx signal path indicated as 176.

For Rx operations, a signal received through the first antenna (Antenna 1) can be routed to the corresponding LNA through the antenna node for the first antenna (Antenna 1) and through a selected filtering path, so as to yield an Rx signal path 172 that duplexes with the foregoing Tx signal path 176. For the second antenna (Antenna 2), a signal received through the second antenna can be routed to the corresponding LNA through the antenna node for the second antenna (Antenna 2) and through a selected filtering path, so as to yield an Rx signal path 174.

Referring to FIG. 9B, a swap mode can be implemented, in which the switch S1a is open and each of the switches S1b and S2 is closed. In such a mode, an amplified RF signal from the PA can be routed through a selected filtering path and to the antenna node for the second antenna (Antenna 2) through the closed switch S1b, the routing line (Cable 1), and the closed switch S2, so as to provide a Tx signal path indicated as 178.

For Rx operations, a signal received through the second antenna (Antenna 2) can be routed to the corresponding LNA through the antenna node for the second antenna (Antenna 2) and through a selected filtering path, so as to yield an Rx signal path 174 that duplexes with the foregoing Tx signal path 178. For the first antenna (Antenna 1), a signal received through the first antenna can be routed to the corresponding LNA through the antenna node for the first antenna (Antenna 1) and through a selected filtering path, so as to yield an Rx signal path 172.

FIGS. 10A and 10B show a direct connect mode and a swap mode, respectively, of an FE architecture 100 in which each of the example PA and the example LNAs has associated with it a plurality of signal filtering paths. In the example of FIGS. 10A and 10B, a TRx functional block is indicated as 150, and an Rx functional block is indicated as 160.

In the example of FIGS. 10A and 10B, the antenna side of each of the PA's assembly of signal filtering paths can be configured to include multiplexing switches to provide switching functionalities associated with the direct connect and swap modes. Various phase shifters, filters and switches associated with such an assembly of signal filtering paths toward the PA can be similar to the example of FIGS. 9A and 9B. Further, each of the two LNAs and their respective assemblies of signal filtering paths can be similar to the example of FIGS. 9A and 9B.

In the example configuration of FIGS. 10A and 10B, more switches are being implemented overall for the PA portion of the TRx functional block 150 when compared to, for example, the example of FIGS. 9A and 9B. However, lower loss can be achieved due to a lower number of switches in a given signal path. More particularly, and referring to the direct connect mode example of FIG. 10A, a signal from each output of the Tx filters is shown to encounter one switch on its path to the first antenna (Antenna 1), instead of two switches in the example of FIG. 9A. Similarly, and referring to the swap mode example of FIG. 10B, a signal from each output of the Tx filters is shown to encounter two switches on its path to the second antenna (Antenna 2), instead of three switches in the example of FIG. 9B.

Referring to the direct connect mode example of FIG. 10A, an amplified and filtered Tx signal in a selected filtering path is shown to be routed to the antenna through a multiplexing switch, so as to yield a signal path 186. The other portion of the multiplexing switch associated with the selected filtering path is shown to be connected to an end of the routing line (Cable 1); and that portion is shown to be open in the example of FIG. 10A.

For Rx operations, a signal received through the first antenna (Antenna 1) can be routed to the corresponding LNA through a selected filtering path, so as to yield an Rx signal path 182 that duplexes with the foregoing Tx signal path 186. For the second antenna (Antenna 2), a signal received through the second antenna can be routed to the corresponding LNA through a selected filtering path, so as to yield an Rx signal path 184.

Referring to the swap mode example of FIG. 10B, an amplified and filtered Tx signal in the selected filtering path is shown to be routed to one end of the routing line (Cable 1) through the multiplexing switch, the routing line (Cable 1), a closed switch S2, and the second antenna (Antenna 2), so as to yield a signal path 188. The portion of the multiplexing switch (associated with the selected Tx filtering path) coupled to the first antenna (Antenna 1) is shown to be open in the example of FIG. 10B.

For Rx operations, a signal received through the second antenna (Antenna 2) can be routed to the corresponding LNA through a selected filtering path, so as to yield an Rx signal path 184 that duplexes with the foregoing Tx signal path 188. For the first antenna (Antenna 1), a signal received through the first antenna can be routed to the corresponding LNA through a selected filtering path, so as to yield an Rx signal path 182.

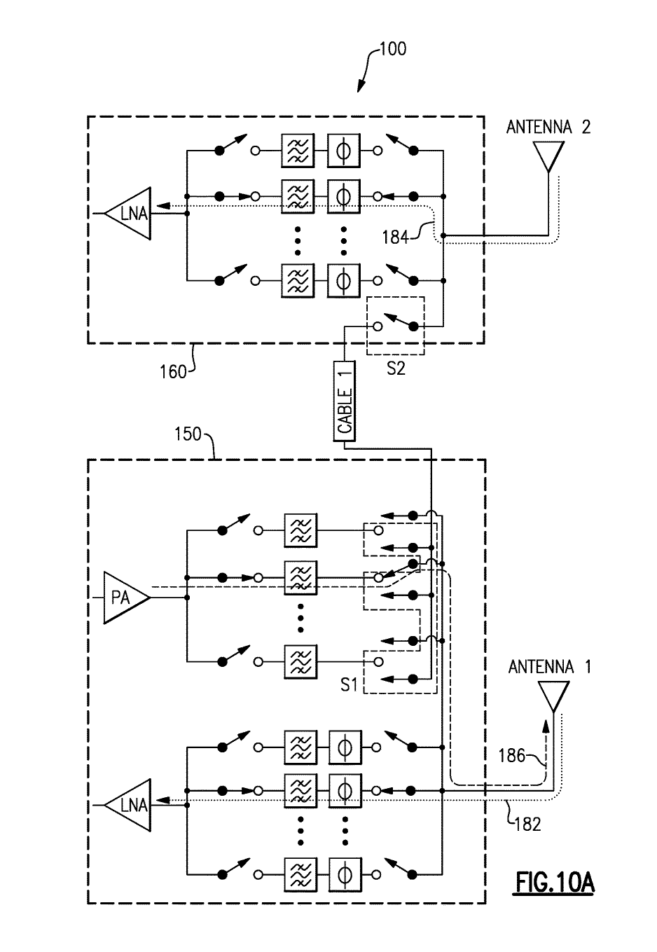

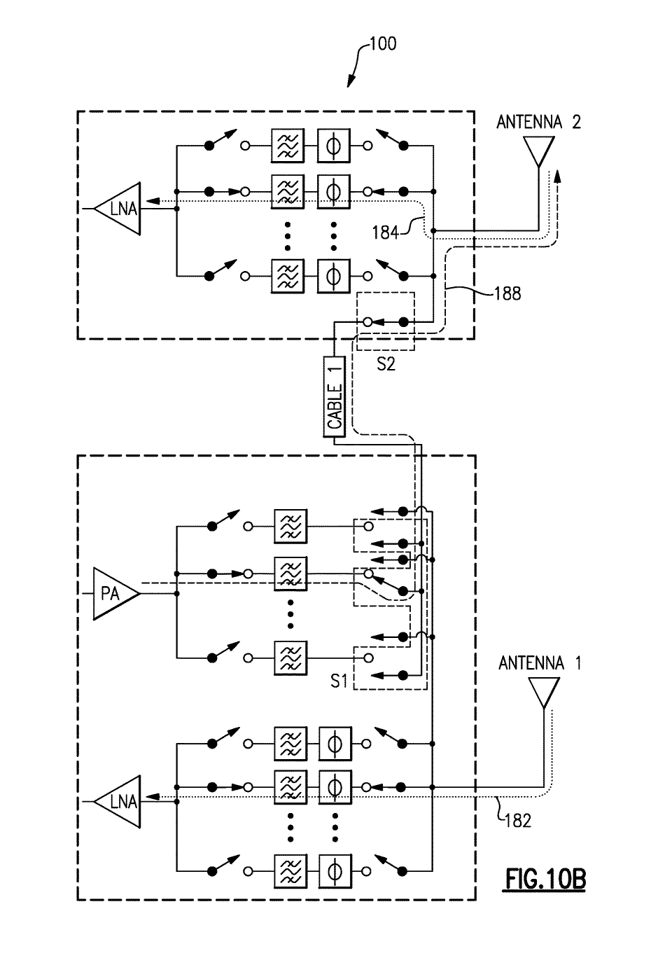

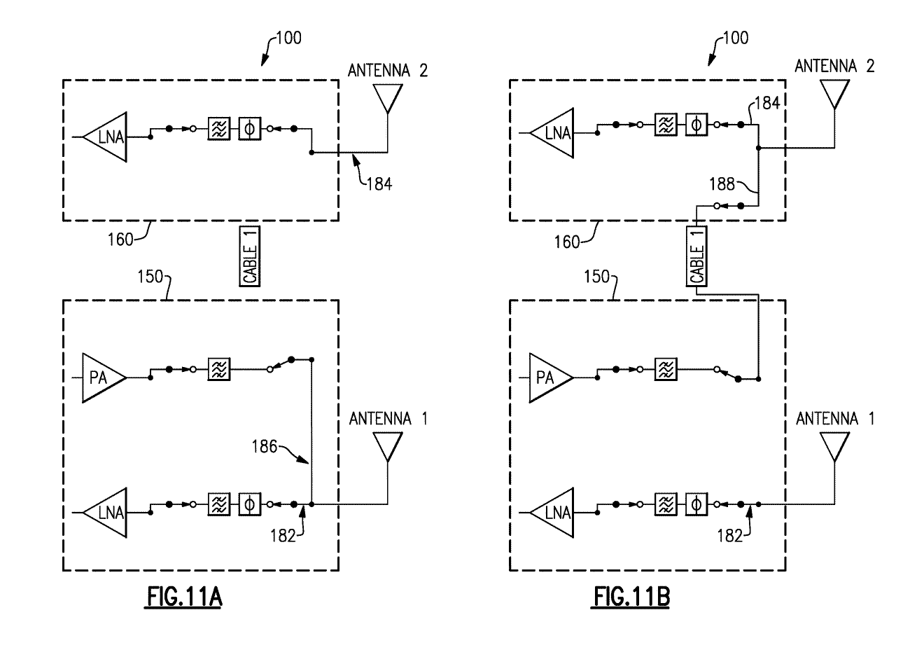

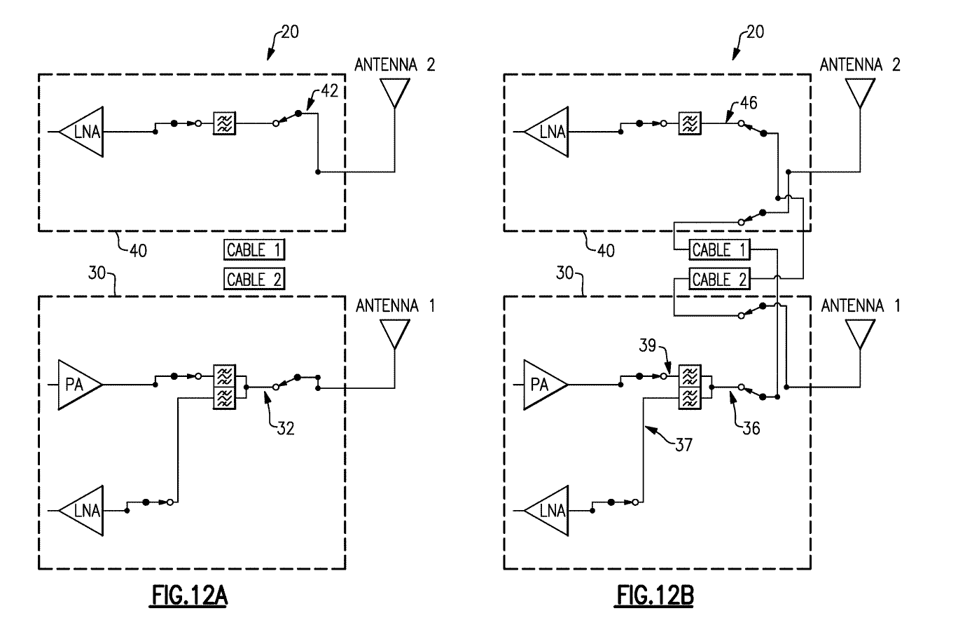

FIGS. 11A and 11B show a direct connect mode and a swap mode, respectively, of an FE architecture 100 that are similar to the example of FIGS. 10A and 10B, but with inactive filtering paths removed for simplification in examples of performance comparisons with a similarly simplified FE architecture 20 (of FIGS. 12A and 12B) that is similar to that example of FIGS. 3A and 3B (and having multiplexer switching functionality on the antenna side of the PA's filtering paths). FIGS. 13-18 show various performance plots associated with such comparisons of the FE architectures 100 of FIGS. 11A and 11B and 20 of FIGS. 12A and 12B.

In FIGS. 11A and 11B, the TRx block 150 and the Rx block 160 can be similar to the example of FIGS. 10A and 10B. Accordingly, signal paths 182, 184 and 186 of FIG. 11A and signal paths 182, 184 and 188 of FIG. 11B can be achieved similar to the corresponding examples described in reference to FIGS. 10A and 10B.

Similarly, in FIGS. 12A and 12B, the TRx block 30 and the Rx block 40 can be similar to the example of FIGS. 3A and 3B. Accordingly, signal paths 32 and 42 of FIG. 12A and signal paths 36, 46, 37 and 39 of FIG. 12B can be achieved similar to the corresponding example paths described in reference to FIGS. 3A and 3B.

FIG. 13 shows a simulated insertion loss (S21) plot for an Rx signal path 182 associated with the first antenna (Antenna 1) and the TRx functionality block 150, when the FE architecture 100 of FIGS. 11A and 11B is in the swap mode. FIG. 14 shows a simulated insertion loss (S21) plot for an Rx signal path 46 associated with the first antenna (Antenna 1) and the Rx functionality block 40, when the FE architecture 20 of FIGS. 12A and 12B is in the swap mode. In both insertion loss plots of FIGS. 13 and 14, the RF signals being processed through the respective Rx signal paths are in an example cellular band B3 (having a Tx frequency range of 1.710 GHz to 1.785 GHz and an Rx frequency range of 1.805 GHz to 1.880 GHz). It will be understood that such a cellular band is an example; and one or more features of the present disclosure can also be utilized with other frequency bands, including other cellular bands.

Referring to the example of FIG. 13, it is noted that sample insertion loss magnitude values are 3.366 dB at 1.805 GHz (the lower boundary of B3 Rx band), 2.019 dB at 1.844 GHz (about mid-portion of B3 Rx band), and 2.838 dB at 1.885 GHz (close to the upper boundary of B3 Rx band). Referring to the example of FIG. 14, it is noted that insertion loss magnitude values at the same frequencies are 5.979 dB, 4.670 dB, and 5.978 dB. Table 1 lists a range of insertion loss magnitude values corresponding to the foregoing configurations of FIGS. 13 and 14.

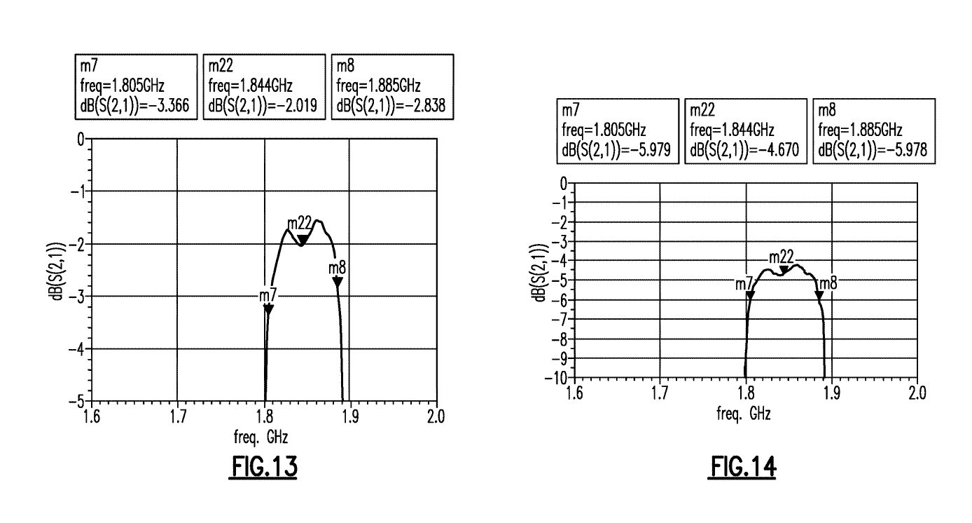

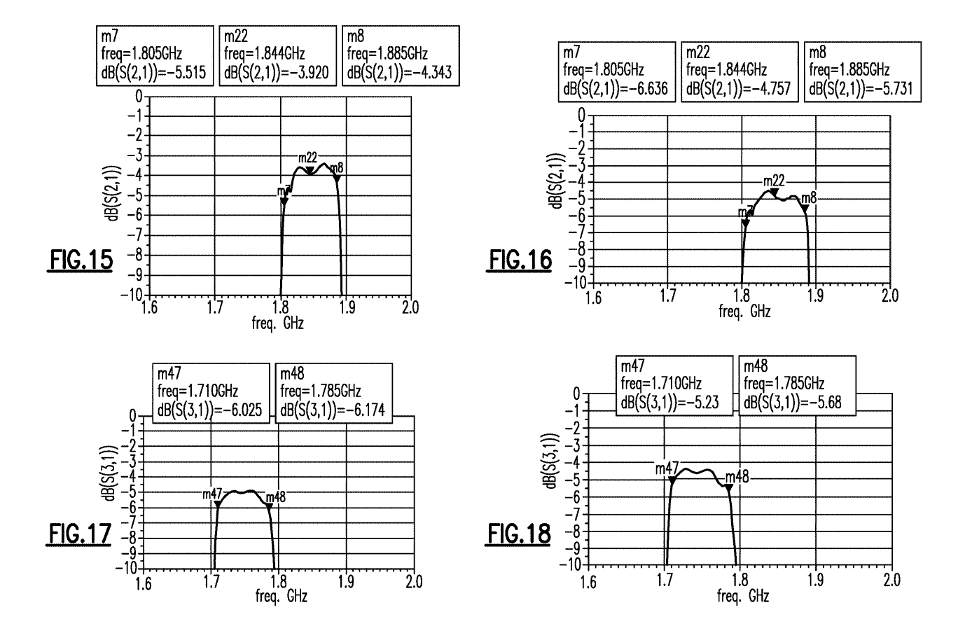

FIG. 15 shows a simulated insertion loss (S21) plot for an Rx signal path 184 associated with the second antenna (Antenna 2) and the Rx functionality block 160, when the FE architecture 100 of FIGS. 11A and 11B is in the swap mode. FIG. 16 shows a simulated insertion loss (S21) plot for an Rx signal path 37 associated with the second antenna (Antenna 2) and the TRx functionality block 30, when the FE architecture 20 of FIGS. 12A and 12B is in the swap mode. In both insertion loss plots of FIGS. 15 and 16, the RF signals being processed through the respective Rx signal paths are in an example cellular band B3.

Referring to the example of FIG. 15, it is noted that sample insertion loss magnitude values are 5.515 dB at 1.805 GHz, 3.920 dB at 1.844 GHz, and 4.343 dB at 1.885 GHz. Referring to the example of FIG. 16, it is noted that insertion loss magnitude values at the same frequencies are 6.636 dB, 4.757 dB, and 5.731 dB. Table 1 lists a range of insertion loss magnitude values corresponding to the foregoing configurations of FIGS. 15 and 16.

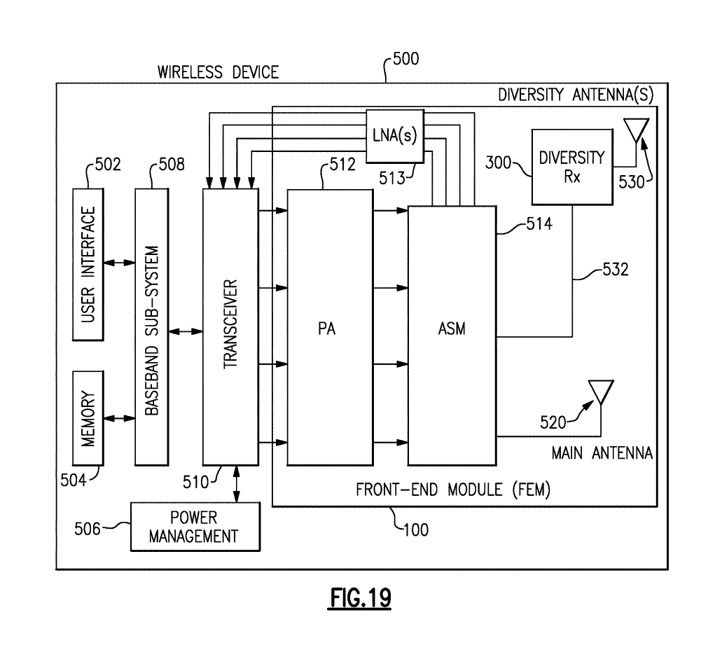

FIG. 17 shows a simulated insertion loss (S31) plot for a Tx signal path 188 associated with the second antenna (Antenna 2) and the TRx functionality block 150, when the FE architecture 100 of FIGS. 11A and 11B is in the swap mode. FIG. 18 shows a simulated Tx insertion loss (S31) plot for a Tx signal path 39 associated with the second antenna (Antenna 2) and the TRx functionality block 30, when the FE architecture 20 of FIGS. 12A and 12B is in the swap mode. In both insertion loss plots of FIGS. 17 and 18, the RF signals being processed through the respective Tx signal paths are in an example cellular band B3.

Referring to the example of FIG. 17, it is noted that sample insertion loss magnitude values are 6.025 dB at 1.710 GHz (the lower boundary of B3 Tx band), and 6.174 dB at 1.785 GHz (the upper boundary of B3 Tx band). Referring to the example of FIG. 18, it is noted that insertion loss magnitude values at the same frequencies are 5.23 dB and 5.68 dB. Table 1 lists a range of insertion loss magnitude values corresponding to the foregoing configurations of FIGS. 17 and 18.

TABLE 1

| | | Insertion loss for | Insertion loss for | Approximate |
|---|---|---|---|---|
| | | architecture 20 of | architecture 100 of | difference between |
| Signal path | Antenna | FIG. 12B (dB) | FIG. 11B (dB) | insertion losses (dB) |
| Rx 46 in FIG. 12B | 1 | 4.2 to 6.0 | 2.0 to 3.4 | 2.2 to 2.6 |
| Rx 182 in FIG. 11B | | | | |
| Rx 37 in FIG. 12B | 2 | 4.5 to 6.6 | 3.5 to 5.5 | 1.0 to 1.1 |
| Rx 184 in FIG. 11B | | | | |
| Tx 39 in FIG. 12B | 2 | 4.4 to 5.7 | 5.0 to 6.0 | −0.6 to −0.3 |
| Tx 188 in FIG. 11B | | | | |

Referring to the example simulation results of Table 1, it is noted that insertion loss is significantly reduced for the Rx operations of the swap mode architecture 100 of FIG. 11B, compared to the counterpart Rx operations of the swap mode architecture 20 of FIG. 12B. More particularly, insertion loss is reduced by about 2.2 dB to 2.6 dB for the Rx operation involving the first antenna (Antenna 1). For the Rx operation involving the second antenna (Antenna 2), insertion loss is reduced by about 1.0 dB. From such example improvements, a combined Rx signal-to-noise ratio (SNR) and sensitivity improvement is about 1.8 dB.

As for the Tx operation in the swap mode, it is noted that insertion loss is increased by about 0.3 dB to 0.6 dB. However, it is further noted that in the foregoing simulation, a shunt impedance from the Rx filter in the Rx functional block (160 in FIG. 11B) present to the Tx signal path was not tuned for the example simulations. Accordingly, one can expect the Tx insertion loss performance to be better than the foregoing example simulations.

It is noted that in simulations of the direct connect mode of the architecture 100 of FIG. 11A and the direct connect mode of the architecture 20 of FIG. 12A, insertion loss performance results are generally the same.

In some implementations, an architecture, device and/or circuit having one or more features described herein can be included in an RF device such as a wireless device. Such an architecture, device and/or circuit can be implemented directly in the wireless device, in one or more modular forms as described herein, or in some combination thereof. In some embodiments, such a wireless device can include, for example, a cellular phone, a smart-phone, a hand-held wireless device with or without phone functionality, a wireless tablet, a wireless router, a wireless modem configured to support machine type communications, a wireless access point, a wireless base station, etc. Although described in the context of wireless devices, it will be understood that one or more features of the present disclosure can also be implemented in other RF systems such as base stations.

FIG. 19 depicts an example wireless device 500 having one or more advantageous features described herein. In some embodiments, such advantageous features can be implemented in a front-end (FE) architecture generally indicated as 100. In some embodiments, such a front-end architecture can be implemented as a front-end module (FEM) 100. Accordingly, the box indicated as 100 in the example of FIG. 19 can be a front-end architecture having one or more features as described herein, a FEM having one or more features as described herein, or some combination thereof.

As described herein, such an FE architecture can include, for example, an assembly of PAs 512, an antenna switch module (ASM) 514, an assembly of LNAs 513, and a diversity Rx module 300. Such components of the FE architecture 100 can operate as described herein with a main antenna 520 and a diversity antenna 530.

As described herein, the diversity Rx module 300 can be configured so that its LNA is relatively close to the diversity antenna 530 which is preferably positioned relatively far from the main antenna 520. Such a diversity module can be configured to provide, for example, swapping functionalities to allow Tx operations through the diversity antenna 520.

PAs in the PA assembly 512 can receive their respective RF signals from a transceiver 510 that can be configured and operated to generate RF signals to be amplified and transmitted, and to process received signals. The transceiver 510 is shown to interact with a baseband sub-system 508 that is configured to provide conversion between data and/or voice signals suitable for a user and RF signals suitable for the transceiver 510. The transceiver 510 is also shown to be connected to a power management component 506 that is configured to manage power for the operation of the wireless device 500. Such power management can also control operations of the baseband sub-system 508 and other components of the wireless device 500.

The baseband sub-system 508 is shown to be connected to a user interface 502 to facilitate various input and output of voice and/or data provided to and received from the user. The baseband sub-system 508 can also be connected to a memory 504 that is configured to store data and/or instructions to facilitate the operation of the wireless device, and/or to provide storage of information for the user.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

One or more features of the present disclosure can be implemented with various cellular frequency bands as described herein. Examples of such bands are listed in Table 2. It will be understood that at least some of the bands can be divided into sub-bands. It will also be understood that one or more features of the present disclosure can be implemented with frequency ranges that do not have designations such as the examples of Table 2.

TABLE 2

| | | Tx Frequency | Rx Frequency |
|---|---|---|---|
| Band | Mode | Range (MHz) | Range (MHz) |
| B1 | FDD | 1,920-1,980 | 2,110-2,170 |
| B2 | FDD | 1,850-1,910 | 1,930-1,990 |
| B3 | FDD | 1,710-1,785 | 1,805-1,880 |
| B4 | FDD | 1,710-1,755 | 2,110-2,155 |
| B5 | FDD | 824-849 | 869-894 |
| B6 | FDD | 830-840 | 875-885 |
| B7 | FDD | 2,500-2,570 | 2,620-2,690 |
| B8 | FDD | 880-915 | 925-960 |
| B9 | FDD | 1,749.9-1,784.9 | 1,844.9-1,879.9 |
| B10 | FDD | 1,710-1,770 | 2,110-2,170 |
| B11 | FDD | 1,427.9-1,447.9 | 1,475.9-1,495.9 |
| B12 | FDD | 699-716 | 729-746 |
| B13 | FDD | 777-787 | 746-756 |
| B14 | FDD | 788-798 | 758-768 |
| B15 | FDD | 1,900-1,920 | 2,600-2,620 |
| B16 | FDD | 2,010-2,025 | 2,585-2,600 |
| B17 | FDD | 704-716 | 734-746 |
| B18 | FDD | 815-830 | 860-875 |
| B19 | FDD | 830-845 | 875-890 |
| B20 | FDD | 832-862 | 791-821 |
| B21 | FDD | 1,447.9-1,462.9 | 1,495.9-1,510.9 |
| B22 | FDD | 3,410-3,490 | 3,510-3,590 |
| B23 | FDD | 2,000-2,020 | 2,180-2,200 |
| B24 | FDD | 1,626.5-1,660.5 | 1,525-1,559 |
| B25 | FDD | 1,850-1,915 | 1,930-1,995 |
| B26 | FDD | 814-849 | 859-894 |
| B27 | FDD | 807-824 | 852-869 |
| B28 | FDD | 703-748 | 758-803 |
| B29 | FDD | N/A | 716-728 |
| B30 | FDD | 2,305-2,315 | 2,350-2,360 |
| B31 | FDD | 452.5-457.5 | 462.5-467.5 |
| B32 | FDD | N/A | 1,452-1,496 |
| B33 | TDD | 1,900-1,920 | 1,900-1,920 |
| B34 | TDD | 2,010-2,025 | 2,010-2,025 |
| B35 | TDD | 1,850-1,910 | 1,850-1,910 |
| B36 | TDD | 1,930-1,990 | 1,930-1,990 |
| B37 | TDD | 1,910-1,930 | 1,910-1,930 |
| B38 | TDD | 2,570-2,620 | 2,570-2,620 |
| B39 | TDD | 1,880-1,920 | 1,880-1,920 |
| B40 | TDD | 2,300-2,400 | 2,300-2,400 |
| B41 | TDD | 2,496-2,690 | 2,496-2,690 |
| B42 | TDD | 3,400-3,600 | 3,400-3,600 |
| B43 | TDD | 3,600-3,800 | 3,600-3,800 |
| B44 | TDD | 703-803 | 703-803 |

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A front-end architecture comprising:
a first receive signal path including a first receive filter coupled to a first antenna;
a second receive signal path including a second receive filter coupled to a second antenna;
a transmit signal path including a transmit filter; and
a signal routing assembly configured to couple the transmit filter to the first antenna in a first mode, and to couple the transmit filter to the second antenna in a second mode.

2. The front-end architecture of claim 1 wherein the first antenna includes a main antenna, and the second antenna includes a diversity antenna.

3. The front-end architecture of claim 2 wherein each of the first receive signal path and the second receive signal path further includes a low-noise amplifier implemented on an output side of the corresponding receive filter.

4. The front-end architecture of claim 3 wherein at least one of the first receive signal path and the second receive signal path further includes a phase shifter implemented on an input side of the corresponding receive filter.

5. The front-end architecture of claim 3 wherein at least one of the first receive signal path and the second receive signal path is one of a plurality of receive signal paths arranged in parallel and configured to allow a selected receive signal path to be operational.

6. The front-end architecture of claim 5 wherein the plurality of parallel receive signal paths share the corresponding low-noise amplifier as a common low-noise amplifier and also have a common output node.

7. The front-end architecture of claim 6 wherein each of the plurality of parallel receive signal paths includes a first band-selection switch implemented on an input side of the corresponding receive filter, and a second band-selection switch implemented on an output side of the corresponding receive filter.

8. The front-end architecture of claim 3 wherein the transmit signal path further includes a power amplifier implemented on an input side of the transmit filter.

9. The front-end architecture of claim 8 wherein the transmit signal path is one of a plurality of transmit signal paths arranged in parallel and configured to allow a selected transmit signal path to be operational.

10. The front-end architecture of claim 9 wherein the plurality of parallel transmit signal paths share the power amplifier as a common power amplifier and also have a common output node.

11. The front-end architecture of claim 10 wherein each of the plurality of parallel transmit signal paths includes a first band-selection switch implemented on an input side of the corresponding transmit filter, and a second band-selection switch implemented on an output side of the corresponding transmit filter.

12. The front-end architecture of claim 1 wherein the signal routing assembly includes a plurality of switches implemented between the first antenna and the second antenna.

13. The front-end architecture of claim 12 wherein the plurality of switches of the signal routing assembly is configured to allow pairing of the transmit signal path with the first receive signal path for a first duplex operation when in the first mode, and pairing of the transmit signal path with the second receive signal path for a second duplex operation when in the second mode.

14. The front-end architecture of claim 13 wherein the plurality of switches includes a first assembly of one or more switches configured to pair the transmit signal path with the first receive signal path when in the first mode, and to allow pairing of the transmit signal path with the second receive signal path when in the second mode.

15. The front-end architecture of claim 14 wherein the first assembly of one or more switches is configured to provide a switching functionality that includes a single-pole-double-throw functionality.

16. The front-end architecture of claim 15 wherein the single pole is coupled to the transmit signal path, a first of the double throw is coupled to the first antenna, and a second of the double throw is coupled to a first end of a routing line.

17. The front-end architecture of claim 14 wherein the first assembly of one or more switches includes a first single-pole-single-throw switch implemented between the transmit filter and the first antenna, and a second single-pole-single-throw switch implemented between the transmit filter and a first end of a routing line.

18. The front-end architecture of claim 14 wherein the first assembly of one or more switches includes a multiplexed switch configured to couple the transmit filter and the first antenna when in the first mode, and to couple the transmit filter and a first end of a routing line when in the second mode.

19. (canceled)

20. (canceled)

21. (canceled)

22. (canceled)

23. (canceled)

24. (canceled)

25. A radio-frequency module comprising:
a packaging substrate configured to receive a plurality of components; and
a signal routing circuit implemented on the packaging substrate, the signal routing circuit including a first antenna node configured to be connected to a first antenna and a first receive signal path, a transmit input node configured to be connected to a transmit signal path, and a swap node configured to be connected to a routing line, the signal routing circuit further configured to couple the transmit input node and the first antenna node when in a first mode, and to couple the transmit input node and the swap node when in a second mode.

26. (canceled)

27. (canceled)

28. (canceled)

29. (canceled)

30. A wireless device comprising:
a transceiver configured to process signals;
a first antenna and a second antenna, each in communication with the transceiver; and
a front-end architecture implemented to route the signals between the transceiver and either or both of the first and second antennas, the front-end architecture including a first receive signal path having a first receive filter coupled to the first antenna, a second receive signal path having a second receive filter coupled to the second antenna, and a transmit signal path having a transmit filter, the front-end architecture further including a signal routing assembly configured to couple the transmit filter to the first antenna in a first mode, and to couple the transmit filter to the second antenna in a second mode.

31. (canceled)

32. (canceled)

33. (canceled)
